(19) United States
(12) Patent Application Publication
(10) Pub. No.: US 2009/0079661 A1
(43) Pub. Date: Mar. 26, 2009

(54) Electrical connector assembly with antenna function

(75) Inventors: Jen-Jou Chang, Tu-cheng (TW); Yao-Pang Lu, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/231,520

(22) Filed: Sep. 2, 2008

(30) Foreign Application Priority Data
Sep. 3, 2007 (CN) 200720046922.1

(51) Int. Cl. H01Q 1/50

(52) U.S. Cl. 343/906

(57) ABSTRACT

An electrical connector assembly (100) with antenna function comprising: an electrical connector (20) comprising a metal shell (21); a metal patch (30) connecting to the metal shell (20) and comprising a radiating element (32) and a connecting element (31); the connecting element connecting to the metal shell that serve as a grounding element; the radiating element, the connecting element, and the metal shell forming an antenna that serves as a medium for transmission and reception of electromagnetic signals.

### BACKGROUND OF THE INVENTION

1. Field of the Invention

The present invention relates to an electrical connector assembly, and more particularly to electrical connector assembly having antenna function.

2. Description of Prior Art

Personal computer technologies have been embraced in many portable electronics devices including: cellular telephones, personal data assistant (PDA), laptop computers, MP3 players, pen-drives, digital video cameras, as well as other mobile devices. Many of the portable electronic devices can be configured to operate with various peripheral devices such as a computer mouse, a computer-writing tablet, a digital camera, as well as others. Moreover, many of the portable electronic devices are also configured to interface with personal computers through a standard interface.

The need for standardization in computer related interfaces, as well as the need for high-speed communication interfaces has lead to the development of the universal serial bus (USB). The USB interface is a high-speed communication protocol that permits devices to communicate at data rates on the order of 48 Mb/s. A revised USB interface such as the USB 2.0 specification can operate at even higher speeds that are on the order of 480 Mb/s. The high speed USB interface has lead to widespread acceptance of external peripheral devices such as USB HDD systems, USB Ethernet devices, USB compact disk writing devices (e.g., CD/RW), as well as other devices.

Today, more and more electronic devices, such as personal computers, notebook computers, electronic appliances, and the like, are normally equipped with an internal antenna that serves as a medium for transmission and reception of electromagnetic signals, such as data, audio, image, and so on. PIFA (Planar Inverted-F Antenna) is a kind of mini antenna usually used in the electronic devices. PIFA has compact structure, light weight, perfect impedance match, desired horizontal polarization and vertical polarization, and is easy to achieve multi-frequency. So, more and more PIFAs are used in the electronic devices. Electrical connector assembly and the antenna of the traditional electronic devices are two separate components. Accordingly, the electrical connector and the antenna respectively occupy inner space of the electronic devices. However, electronic devices trend to miniaturization developing. For saving inner space of the electronic devices, many components being integrated is a question.

Hence, in this art, an electrical connector assembly with antenna function to overcome the above-mentioned disadvantages of the prior art will be described in detail in the following embodiment.

### SUMMARY OF THE INVENTION

An object of the present invention is to provide an electrical connector assembly which has antenna function.

To achieve the aforementioned object, the present invention provides an electrical connector assembly with antenna function comprising: an electrical connector comprising a metal shell; a metal patch connecting to the metal shell and comprising a radiating element and a connecting element; the connecting element connecting to the metal shell that serve as a grounding element; the radiating element, the connecting element, and the metal shell forming an antenna that serves as a medium for transmission and reception of electromagnetic signals.

Additional novel features and advantages of the present invention will become apparent by reference to the following detailed description when taken in conjunction with the accompanying drawings.

### BRIEF DESCRIPTION OF THE DRAWINGS

FIG. 1 is a perspective view of an electrical connector assembly with antenna in accordance with a preferred embodiment of the present invention;

FIG. 2 is a perspective view of an electrical connector with a metal patch;

FIG. 3 is a view similar to FIG. 2, but from a different aspect; and

FIG. 4 is a test chart recording for the antenna of the in accordance with a preferred embodiment of the present invention, showing Voltage Standing Wave Ratio (VSWR) of frequency band.

### DETAILED DESCRIPTION OF THE INVENTION

Reference will now be made in detail to the preferred embodiment of the present invention.

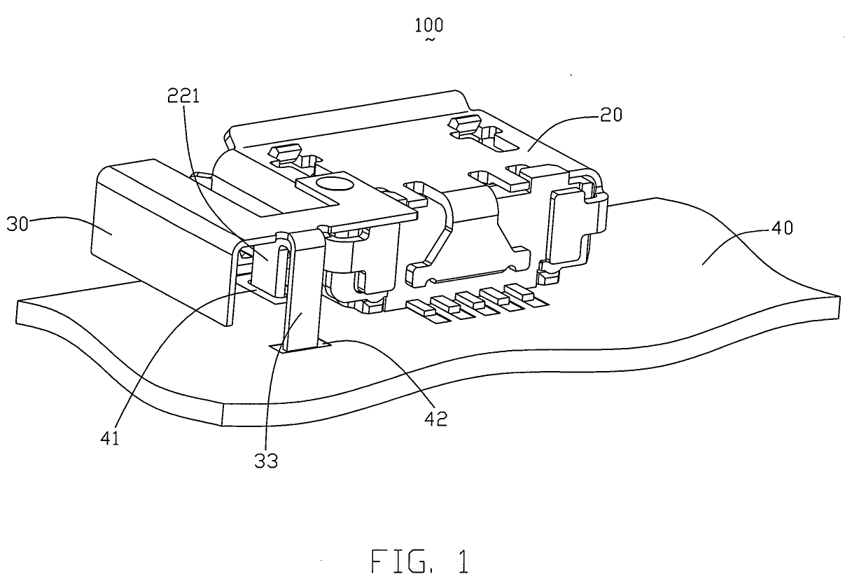

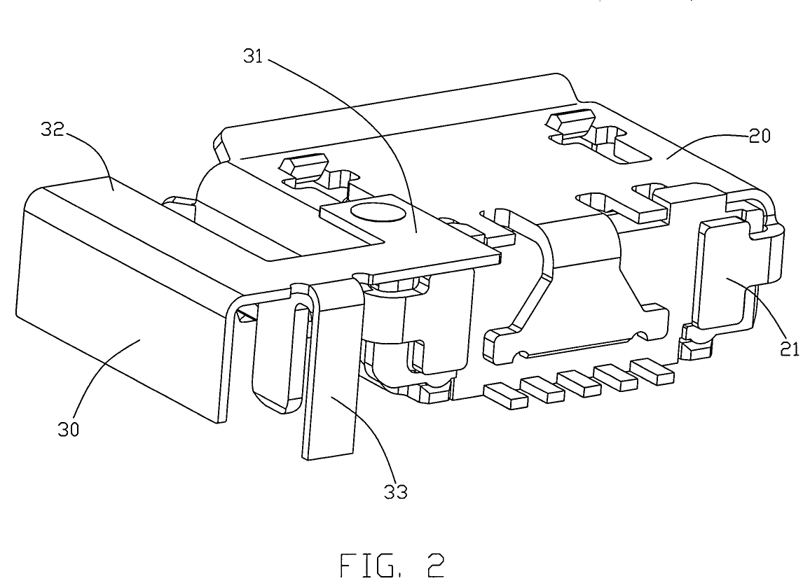

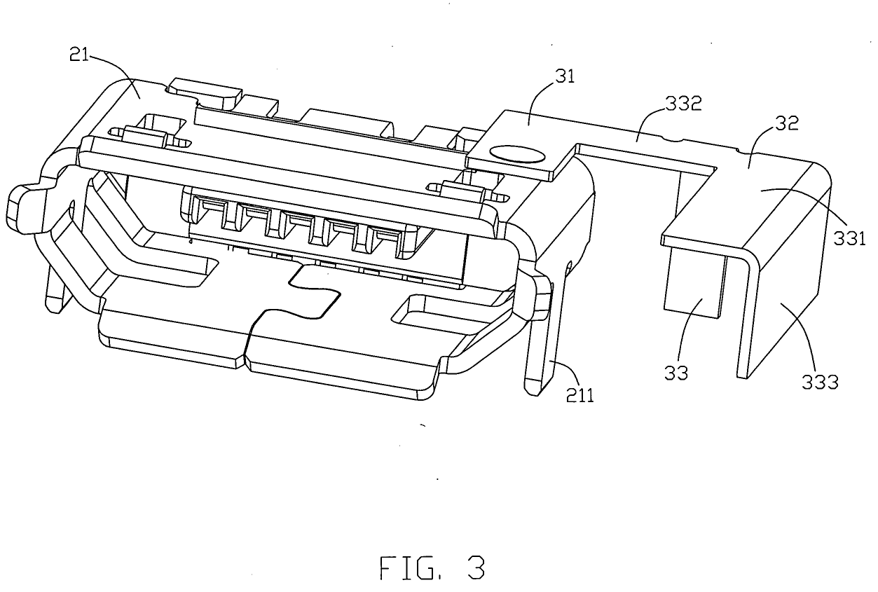

Referring to FIGS. 1-3, an electrical connector assembly 100 with antenna function in accordance with a preferred embodiment of the present invention comprises a micro USB electrical connector 20, a metal patch 30, and a PCB 40.

The USB electrical connector 20 comprises an insulating body (not shown), several contacts (not shown) received in the insulating body, and a metal shell 21 covering the insulating body. The metal shell 21 comprises a welding element 211 extending vertically and downwardly from a bottom surface of the metal shell 21.

The metal patch 30 connects to the metal shell 21 of the USB connector 20. Accordingly, the metal patch 30 and the metal shell 21 forms an antenna that serves as a medium for transmission and reception of electromagnetic signals. The metal patch 30 comprises a connecting element 31 lying in a first plane and connecting to the metal shell 21, a radiating element 32 connecting to the connecting element 31, a feeding element 33 extending from a joint of the connecting element 31 and the radiating element 32. The radiating element 32 comprises a first rectangle-shape radiating branch 331, a second radiating branch 332 connecting the radiating branch 331 and the connecting element 31, and a third radiating branch 333 extending vertically from an end of the first radiating branch 331 in a second plane. The second radiating branch 332 is vertical to the first radiating branch 331 in the first plane. The feeding element 33 lies in a third plane. The first plane is vertical to the second plane, and the third plane is vertical to the first plane and the second plane respectively. The electrical connector assembly 100 is mounted on the PCB 40. The welding element 211 of the electrical connector 20 and the feeding element 33 are soldered respectively to suitable circuit of the PCB 40.

The PCB 40 comprises a pair of first slot 41 for receiving the welding element 211, a second slot 42 for receiving the feeding element 33, and feeding circuit and grounding circuit (not shown). The metal shell 21 electrically connects to the grounding circuit. The radiating element 32 electrically connects to the feeding circuit.

The electrical connector 20 of the present invention is not limited to the micro USB connector of the preferred embodiment, other types electrical connector as well as used in present invention, such as USB connector, HDMI connector, IEEE1394 connector and so on.

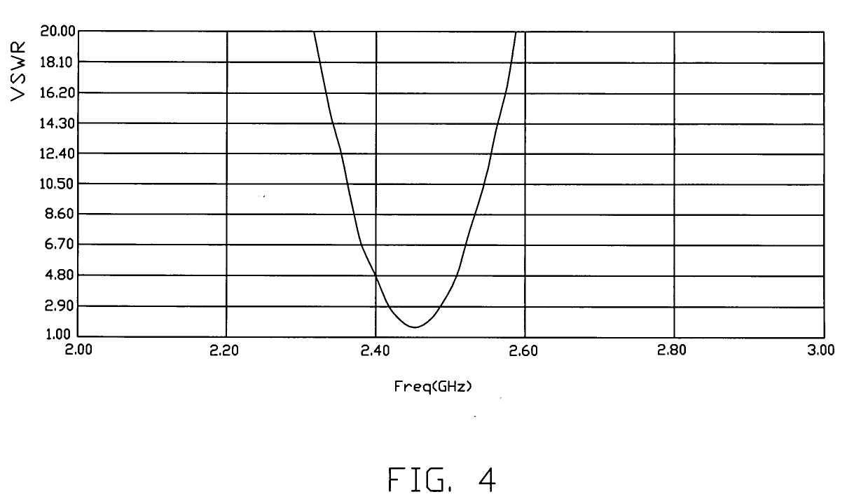

FIG. 4 is a test chart of Voltage Standing Wave Ratio of the electrical connector assembly 100 as an antenna. Referring to FIG. 4, operating frequency band of the electrical connector assembly 100 as an antenna are 2.4 GHz-2.5 GHz.

What is claimed is:

1. An electrical connector assembly with antenna function, comprising:
an electrical connector comprising a metal shell;
a metal patch connecting to the metal shell and comprising a radiating element and a connecting element, the connecting element connects to the metal shell that serves as a grounding element, and the metal patch and the metal shell form an antenna that serves as a medium for transmission and reception of electromagnetic signals.

2. The electrical connector assembly as claimed in claim 1, wherein said electrical connector assembly comprises a PCB having a feeding circuit and a grounding circuit.

3. The electrical connector assembly as claimed in claim 2, wherein said electrical connector is mounted on the PCB.

4. The electrical connector assembly as claimed in claim 2, wherein said metal patch comprises a feeding element extending from a joint of the radiating element and the connecting element.

5. The electrical connector assembly as claimed in claim 4, wherein said feeding element electrically connects to the feeding circuit.

6. The electrical connector assembly as claimed in claim 2, wherein said metal shell comprises a pair of welding elements soldering to the PCB.

7. The electrical connector assembly as claimed in claim 4, wherein said feeding element is soldered to the PCB and electrically connects to the feeding circuit.

8. The electrical connector assembly as claimed in claim 1, wherein said radiating element comprises a first rectangle-shape radiating branch, a second radiating branch connecting the radiating branch and the connecting element, and a third radiating branch extending vertically from an end of the first radiating branch.

9. The electrical connector assembly as claimed in claim 9, wherein said connecting element lies in a first plane, the third radiating branch lies in a second plane, The feeding element lies in a third plane.

10. The electrical connector assembly as claimed in claim 10, wherein said first plane is vertical to the second plane, and the third plane is vertical to the first plane and the second plane respectively.

11. The electrical connector assembly as claimed in claim 1, wherein the radiating element, the connecting element, and the metal shell form an antenna that serves as a medium for transmission and reception of electromagnetic signals.

12. An electrical connector assembly comprising:
an electrical connector including an insulative housing enclosed in a metallic shell, said shell including at least one mounting leg for mounting to a printed circuit board;
a plurality of contacts disposed in the housing and including mounting legs for mounting to the printed circuit board;
a metal patch positioned beside the connector and defining a connecting element electrically and mechanically connecting to the shell for grounding, at least one radiating element and one feeding element cooperating with said shell to commonly form an antenna unit.

13. The electrical connector assembly as claimed in claim 12, wherein said metal patch is located by a longitudinal end of said connector.

14. The electrical connector assembly as claimed in claim 12, wherein the feeding element extends downwardly longer than other portions of the metal patch so as to assure only said feeding element reaches the printed circuit board on which said connector is mounted.

15. The electrical connector assembly as claimed in claim 12, wherein said feeding element is located around a rear face of the connector.

16. The electrical connector assembly as claimed in claim 12, wherein said metal patch defines first and second planes perpendicular to each other under a condition that the feeding element is located in the first plane, and the radiating element and the connecting element are located in the second plane.

17. The electrical connector assembly as claimed in claim 16, wherein said metal patch further defines a third plane perpendicular to both said first and second planes under a condition another radiating element is located in the third plane.

18. The electrical connector assembly as claimed in claim 12, wherein said connecting element is engaged with a top wall of the shell.
